(19) United States
(12) Patent Application Publication
(10) Pub. No.: US 2014/0258082 A1
(43) Pub. Date: Sep. 11, 2014

(54) CROSS BORDER COMPETENCIES TOOL

(71) Applicant: BANK OF AMERICA CORPORATION, Charlotte, NC (US)

(72) Inventors: Kevin Malvey, Charlotte, NC (US); George S. Carey, Cleveland Heights, OH (US); Molly Oxford, Mesquite, TX (US); Stacie Barber, Mount Holly, NC (US); Lawrence R. Healy, Charlotte, NC (US); Diane Carleton, Dallas, TX (US); Paul Marchetti, New York City, NY (US); Gary Flieger, San Francisco, CA (US); Katina Kasling, Richardson, TX (US)

(73) Assignee: Bank of America Corporation, Charlotte, NC (US)

(21) Appl. No.: 13/785,828

(22) Filed: Mar. 5, 2013

(51) Int. Cl. G06Q 40/02

(52) U.S. Cl. CPC G06Q 40/025
USPC 705/38

(57) ABSTRACT

According to one embodiment, an apparatus may comprise a memory unit and a processing unit. The memory unit may store loan and tax regulations of a plurality of countries. The processing unit may receive a country designation and a currency designation. The processing unit may determine, based at least in part upon the loan regulations associated with the country designation, at least one service location that is allowed to service a loan according to the currency designation and the country designation. The processing unit may further determine, based at least in part upon the retrieved tax regulations associated with the country designation, a tax withholding on the loan.

### TECHNICAL FIELD

This disclosure relates generally to a tool for enhancing competency of foreign regulations.

### BACKGROUND

As the world becomes increasingly digital and interconnected, regulation of foreign transactions and services grows more complex and intricate. When a client requests a merchant to provide a good or service in a foreign country, the merchant should know the regulations of that country that pertain to the requested good or service. However, inexperienced merchants may not know all the relevant regulations, which may cause the transaction to be hindered later on.

### SUMMARY OF THE DISCLOSURE

According to one embodiment, an apparatus may comprise a memory unit and a processing unit. The memory unit may store loan and tax regulations of a plurality of countries. The processing unit may receive a country designation and a currency designation. The processing unit may determine, based at least in part upon the loan regulations associated with the country designation, at least one service location that is allowed to service a loan according to the currency designation and the country designation. The processing unit may further determine, based at least in part upon the retrieved tax regulations associated with the country designation, a tax withholding on the loan.

Certain embodiments may provide one or more technical advantages. A technical advantage of one embodiment includes reduced network traffic by minimizing the number of data retrievals by service providers. By retrieving and storing foreign regulations, the embodiment apparatus may reduce the number of data retrievals each service provider must perform in order to determine how best to provide the services in a particular country. Certain embodiments may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present disclosure, reference is now made to the following description, taken in conjunction with the accompanying drawings, in which:

FIG. 1 illustrates a system implementing a cross border competencies tool;

FIG. 2 illustrates a server of the system of FIG. 1;

FIG. 3 is a flowchart illustrating a method implemented by the server of FIG. 1.

### DETAILED DESCRIPTION

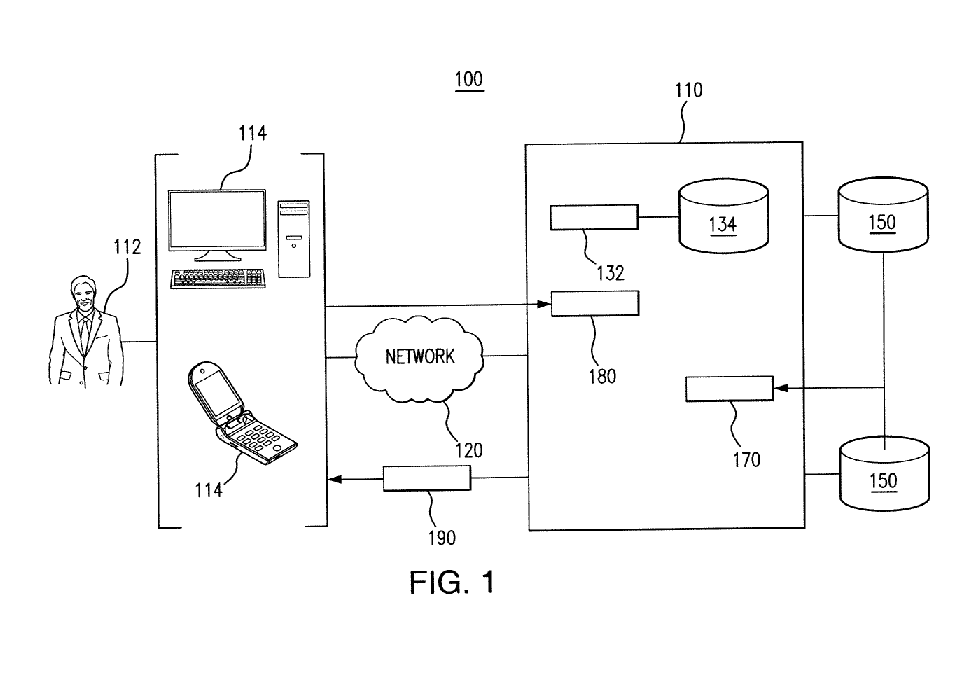

Embodiments of the present disclosure and its advantages are best understood by referring to FIGS. 1 through 3 of the drawings, like numerals being used for like and corresponding parts of the various drawings.

As the world becomes increasingly digital and interconnected, regulation of foreign transactions and services grows more complex and intricate. The regulations, both of the source country and the destination country, may give rise to several issues including issues associated with tax, licensing, documentation, etc. For example, suppose a company based in country A wishes to build a warehouse in country B. In order for the company to build the warehouse in country B, the company would need to acquire financing in country B. The regulations of country A and/or country B may determine which loan provider the company uses, how much money the company may borrow, what type of loan is allowed, the amount of tax withholding on the loan, and other related issues. However, loan providers in country B and country A may not be familiar with the regulations of the other country. As a result, the process by which the company acquires financing for its new warehouse may be slow and inefficient.

The proposed system may gather information relevant to transactions and services in multiple countries. The information may then be used to make transactions and services more efficient. In the previous example, the system may be used to gather regulations pertinent to the financing needed to build the warehouse in country B. For example, the system may gather loan regulations and tax regulations of country A and country B.

Furthermore, the system may gather information associated with the loan providers' ability to service a loan in country B. For example, the system may gather the office locations of the loan provider in country A as well as employee information of the office locations. In this manner, when the company requests a loan from the loan provider in country A, the system may provide answers to questions such as which office location is best suited to service the loan in country B, what tax implications are there for a loan provider in country A to provide a loan in the currency of country B, and is there any special documentation required to provide a loan in country B.

In this manner, a service provider may provide services efficiently in a foreign country even if the service provider is not familiar with the regulations of the foreign country. Moreover, the service provider may efficiently determine whether the service provider is able and/or is allowed to provide services in a particular country. These efficiency gains may lead to reduced network traffic as representatives of the service provider make fewer calls and data pulls in order to determine whether the service provider can provide services in a foreign country.

FIG. 1 illustrates a system 100 implementing a cross-border competencies tool. As provided in FIG. 1, system 100 may include a device 114, network 120, server 110, and databases 150. A user 112 may use device 114 to access server 110 over network 120. Server 110 may be used to aggregate and analyze various regulations of particular countries. Server 110 may then return the results of that analysis to device 114. In this manner, system 100 may allow user 112 to determine the most efficient way of providing services in a particular country.

To better understand the functions of system 100 and server 110, an example of servicing a loan will be used. However, it is understood that system 100 and server 110 may be used in a variety of contexts and areas in order to help user 112 understand the regulations of a foreign country, such as providing utilities, construction and zoning, sale of food products, and labor management.

User 112 may use device 114 to interact with system 100. For example, user 112 may use device 114 to request information about a country. Server 110 may then return the requested information to device 114. Device 114 may use a processor and a memory to execute an application in order to perform any of the functions described herein. Device 114 may be a mobile device such as a cell phone or tablet. Device 114 may be a personal computer, a workstation, a laptop, a wireless or cellular telephone, an electronic notebook, a personal digital assistant, a tablet, or any other device (wireless, wireline, or otherwise) capable of receiving, processing, storing, and/or communicating information with other components of system 100. Device 114 may also include a user interface, such as a display, a touchscreen, a microphone, keypad, or other appropriate terminal equipment usable by user 112.

Network 120 facilitates communications between device 114 and server 110. This disclosure contemplates any suitable network 120 operable to facilitate communication between the components of system 100. Network 120 may include any interconnecting system capable of transmitting audio, video, signals, data, messages, or any combination of the preceding. Network 120 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components. This disclosure contemplates end networks having one or more of the described properties of network 120.

Server 110 may perform various functions in order to provide information about requested countries to user 112. Server 110 may include a processor 132 and a memory 134 that performs the functions described herein. For example, memory 134 may perform storage functions such as storing loan regulations of foreign countries and processor 132 may analyze these loan regulations to determine a best course of conduct for user 112.

Memory 134 may store, either permanently or temporarily, data, operational software, or other information for processor 132. Memory 134 may include any one or a combination of volatile or non-volatile local or remote devices suitable for storing information. For example, memory 134 may include random access memory (RAM), read only memory (ROM), magnetic storage devices, optical storage devices, or any other suitable information storage device or a combination of these devices.

Processor 132 may control the operation and administration of server 110 by processing information received from network 120 and memory 134. Processor 132 may include any hardware and/or software that operates to control and process information. Processor 132 may be a programmable logic device, a microcontroller, a microprocessor, any suitable processing device, or any suitable combination of the preceding.

Server 110 may gather information from databases 150. Databases 150 may store information associated with particular countries. For example, databases 150 may store loan regulations and tax regulations associated with various countries. Server 110 may gather and store this information from databases 150. After the information has been stored, server 110 may use that information to respond to requests 180 from user 112.

Server 110 may receive regulations 170 from databases 150. Regulations 170 may include loan regulations and/or tax regulations associated with various countries. For example, the loan regulations may indicate whether a foreign office is allowed to service a loan into that country, whether same-day funding and/or a swing-line loan is allowed, whether a cross-border license such as a European Economic Area (EEA) passport is required to service a loan in the country, and other requirements associated with servicing the loan. These other requirements may include booking requirements, documentation requirements, execution requirements, and/or disclosure requirements associated with servicing the loan. For example, regulations 170 may indicate that in order for a loan to be effective in a particular country, the loan must be written and executed by three witnesses and the terms of the loan must be disclosed to a particular agency. Server 110 may then use regulations 170 to inform user 112 how best to service a loan to a particular country.

In particular embodiments, server 110 may gather and store general business regulations from databases 150. For example, the business regulations may indicate restrictions or requirements associated with soliciting business in a particular country. As another example, the business regulations may indicate restrictions and/or requirements associated with providing business advice in a particular country. Server 110 may then use these business regulations to resolve particular issues associated with providing business in a particular country.

Server 110 may gather and store employee information from databases 150. For example, the employee information may include the names and language proficiencies of employees of a particular service provider. When the loan provider is asked to service a loan in country B, server 110 may use the employee information to determine which employees and/or office locations are best suited to service that loan. For example, an employee who is fluent in the language of country B may be best suited to service the loan in country B.

Server 110 may further gather and store client preferences. Client preferences may be provided by user 112 and/or stored in databases 150. Server 110 may use client preferences to make recommendations when multiple options are available. For example, the client preferences may indicate that a client prefers to have loans serviced in country A even if the loan is to be provided in country B. If the client needs a loan in country B, server 110 may determine, based on regulations 170, that the loan may be serviced in either country A or country B. Then based on the client preferences, server 110 may determine that it would be more desirable to service the loan in country A than country B. Server 110 may then provide a ranking or prioritization of service locations. For example, server 110 may indicate that servicing the loan in country A is preferable to servicing the loan in country B.

Server 110 may receive a request 180 from device 114. Request 180 may indicate a service request in a particular country. For example, request 180 may indicate that a company in country A is requesting a loan be provided in country B. Request 180 may also indicate that the loan should be provided in a particular currency. Server 110 may use stored information gathered from databases 150, such as regulations 170, to respond to request 180. For example, server 110 may determine based on the stored information that a loan provider is allowed to service a loan in country B according to the designated currency. As another example, server 110 may determine the amount of tax withholding on the loan required by the tax regulations of country B.

Server 110 may use information gathered and stored from databases 150 to form a response 190 to request 180. Server 110 may then communicate response 190 to device 114. Response 190 may include information associated with providing a requested service. For example, if the requested service is providing a loan in a particular country, then response 190 would include information associated with providing that loan in the country. As an example, response 190 may indicate the office locations that are allowed to service a loan of a particular currency in a designated country. As another example, response 190 may indicate the tax withholdings on the loan.

In particular embodiments, response 190 may indicate additional information associated with servicing a loan in a particular country. For example, based on stored client preferences, response 190 may indicate a ranking or priority of office locations that are capable of servicing the loan in the country. As another example, response 190 may indicate whether particular types of loans, such as same-day funding and/or a swing-line loan, are allowed in the country. As yet another example, response 190 may indicate whether a cross-border license, such as an EEA passport, is required to service a loan to the country.

Response 190 may also indicate general requirements and disclosures associated with the loan. For example, response 190 may indicate a booking requirement, a documentation requirement, and an execution requirement associated with the loan. As another example, response 190 may indicate disclosure obligations associated with servicing the loan in the country. By following these requirements and obligations, a loan provider may be confident that the terms of the loan are enforceable in the country.

Response 190 may also indicate certain business requirements. For example, response 190 may indicate particular restrictions or requirements associated with soliciting business in the country. As another example, response 190 may indicate restrictions and requirements associated with providing business advice in the country. In particular embodiments, response 190 may also indicate employees who are capable of assisting and servicing the loan in the country. For example, response 190 may indicate the employees who are fluent in the language of the country.

In operation, system 100 may assist service providers in efficiently providing services to foreign countries. In particular embodiments, the service provider may be a loan provider who has been requested by a company based in country A to service a loan in country B. User 112, who may be a representative of the loan provider, may use device 114 to communicate with server 110 in order to determine how best to service the requested loan.

User 112 may designate country B as the destination country and the currency of country B as the desired currency on device 114. Device 114 may then communicate a request 180 to server 110. The request 180 may indicate that a loan to country B has been requested by a company based in country A and that the loan should be in the currency of country B.

Server 110 may use information gathered and stored from databases 150 to respond to request 180. The information may include regulations 170 associated with various countries. Server 110 may retrieve the regulations 170 associated with country B in order to determine the best way of servicing a loan to country B. For example, server 110 may determine which office locations of the loan provider are allowed to service a loan to country B. As another example, server 110 may determine the tax withholdings on the loan required by the tax regulations of country B. When responding to request 180, server 110 may indicate which office locations are allowed to service the loan and how much tax to withhold.

As another example, regulations 170 may indicate whether particular types of loans are allowed in country B such as same-day funding and swing-line loans. Regulations 170 may also indicate whether a cross-border license, such as an EEA passport, is required to service a loan in country B. Lastly, regulations 170 may indicate various requirements and obligations associated with servicing a loan in country B. For example, regulations 170 may indicate booking requirements, documentation requirements, execution requirements, and disclosure obligations associated with servicing a loan in country B. When responding to request 180, server 110 may indicate these requirements and obligations.

Server 110 may also gather and store the preferences of the company requesting the loan. For example, server 110 may gather and store the preferred location through which loans are to be serviced. If the company prefers that loans be serviced in country A rather than country B, then server 110 will store the preference that loans of the company should be serviced in country A. When responding to request 180, server 110 may rank office locations in country A above those in country B.

Server 110 may further store business regulations of country B. For example, server 110 may store restrictions and requirements associated with soliciting business in country B. As another example, server 110 may store restrictions and requirements associated with providing business advice in country B. When responding to request 180, server 110 may indicate these business restrictions and requirements, so that user 112 complies with the laws of country B in the course of doing business.

Server 110 may further gather and store employee information. For example, server 110 may gather and store information about the employees of the loan provider, such as their names, home office locations, and language proficiencies. Server 110 may then use this information to determine which employees are best suited to service the loan to country B.

Server 110 may use the stored information to form a response 190 in response to request 180. Server 110 may communicate response 190 to device 114. Response 190 may include information associated with servicing a loan to country B for the company based in country A. For example, response 190 may indicate whether the loan provider is allowed to service the loan according to the currency of country B. As another example, response 190 may indicate the tax withholding on the loan in order to comply with the tax regulations of country B.

Response 190 may also indicate whether particular types of loans are available, such as same-day funding and swing-line loans. Furthermore, response 190 may indicate whether a cross-border license, such as an EEA passport, is required to service the loan. Moreover, response 190 may indicate the booking requirements, documentation requirements, execution requirements, and disclosure obligations associated with servicing the loan.

Device 114 may receive response 190 and present the information to user 112. Then, based on this information, user 112 may determine how best to service the loan for the company to country B. In this manner, the loan provider may efficiently service a loan to country B even though the representative of the loan provider is not familiar with the intricacies and nuances of the regulations of country B. As a result, server network traffic may be reduced because user 112 would not have to query each database 150 in order to determine how best to service the loan.

A component of system 100 may include an interface, logic, memory, and/or other suitable element. An interface receives input, sends output, processes the input and/or output, and/or performs other suitable operations. An interface may comprise hardware and/or software. Logic performs the operations of the component. For example, logic executes instructions to generate output from input. Logic may include hardware, software, and/or other logic. Logic may be encoded in one or more non-transitory, tangible media, such as a computer readable storage medium or any other suitable tangible medium, and may perform operations when executed by a computer. Certain logic, such as a processor, may manage the operation of a component. Examples of a processor include one or more computers, one or more microprocessors, one or more applications, and/or other logic.

Modifications, additions, or omissions may be made to system 100 without departing from the scope of the invention. For example, server 110 may retrieve information from databases 150 for a request 180 after receiving request 180. As another example, response 190 may include empty or null fields associated with missing information. Furthermore, the components of system 10 may be integrated or separated. For example, voice-based management system 108 may be incorporated into on-line account management system 106.

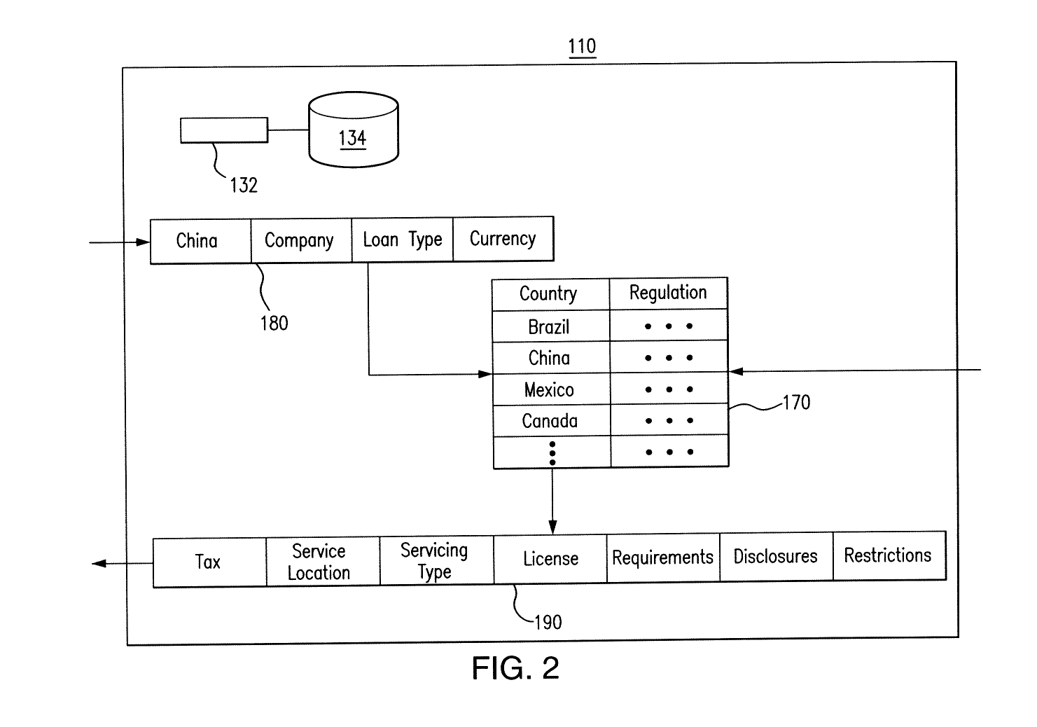

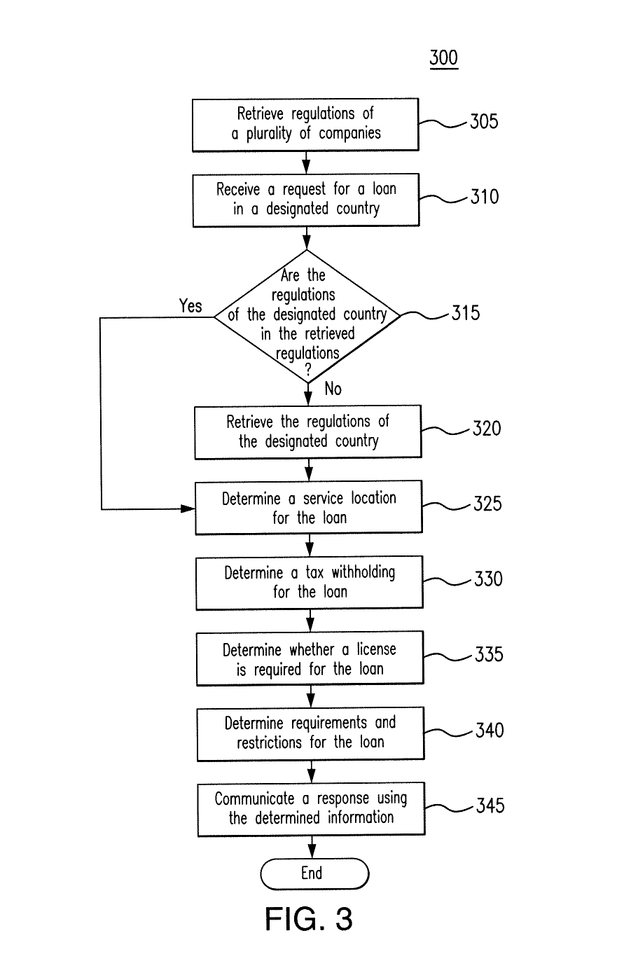

FIGS. 2 and 3 further illustrate the operation of system 100. FIG. 2 provides more detail as to the operation of server 110. FIG. 3 illustrates a method implemented by server 110.

FIG. 2 illustrates a server 110 of the system 100 of FIG. 1. As provided by FIG. 2, server 110 may gather and store regulations 170. Server 110 may further receive a request 180. Server 110 may then use regulations 170 in order to form a response 190 to request 180. Server 110 may then communicate response 190.

Regulations 170 may be gathered and stored from databases 150. In the illustrated example of FIG. 2, regulations 170 include the regulations of various countries such as Brazil, China, Mexico, and Canada. These regulations 170 may be the loan regulations of these countries.

Request 180 may indicate aspects of the requested service. In the example of servicing the loan, request 180 may include information such as the name of the client requesting the loan, the destination country of the loan, and the loan type. Request 180 may also indicate a currency associated with the loan. For example, the company may have requested a loan in China to be provided in U.S. dollars. As a result, request 180 would indicate a currency of U.S. dollars. In the illustrated example of FIG. 2, request 180 may indicate that the company has requested a loan of a particular type in order to build a new warehouse in China.

After server 110 receives request 180, server 110 may use regulations 170 to determine information pertinent to servicing the loan. In the illustrated example, server 110 may reference the regulations 170 of China to respond to request 180. Server 110 may then use this information to form response 190. After response 190 is formed, server 110 may communicate response 190 to device 114 in order to inform user 112 on how best to service the requested loan.

Response 190 may include information associated with servicing the loan in China. For example, response 190 may include tax information, such as the amount of tax withholding on the loan required by Chinese regulations. Response 190 may further include service locations, such as office locations, of the loan provider that can provide the loan in China. As an example, response 190 may indicate that a loan office in New York and a loan office in Hong Kong can service the loan in China.

Response 190 may further indicate servicing types that are available for the loan. As an example, response 190 may indicate that same-day funding and/or swingline loans are available for the loan to China. Response 190 may also indicate whether a cross-border license, such as an EEA passport, is required to service the loan in China.

Response 190 may also indicate various requirements, restrictions, and disclosures associated with servicing the loan in China. For example, response 190 may indicate the booking requirements, documentation requirements, execution requirements, and disclosure obligations as required by Chinese regulations. For example, Chinese regulations may require that the loan agreement be written and executed by two witnessing parties and that the terms of the loan be disclosed to a government agency in order for the loan to be valid.

In particular embodiments, response 190 may further indicate a ranking or prioritization of office locations that are suited to service the loan. For example, if an office location in New York and an office location in Hong Kong are both suited to service the loan in China, response 190 may indicate that the office location in New York is preferred over the office location in Hong Kong. Server 110 may have determined the rankings and/or prioritizations based on stored client preferences. For example, server 110 may have stored information indicating that the company prefers loans to be serviced in the United States rather than China.

In particular embodiments, response 190 may further indicate employees of the loan provider who are best suited for servicing the loan in China. As an example, if the company chooses to service the loan out of the Hong Kong office, response 190 may indicate the names of employees who are fluent in Chinese. In this manner, response 190 would indicate the employees of the loan provider who are best suited for servicing the loan to China. Server 110 may determine these employees based on stored employee information gathered from an employee database.

Response 190 may also indicate general business requirements as indicated by the Chinese regulations. For example, response 190 may indicate whether the desired office location is allowed to solicit business in China. Furthermore, response 190 may indicate whether the office location is allowed to provide business advice in China.

Server 110 may communicate response 190 to a device 114 so that user 112 may view the determined information. By using this information, user 112 may determine how best to service the company's loan in China.

FIG. 3 is a flowchart illustrating a method 300 implemented by server 110 of FIG. 1. Server 110 may begin in step 305 by retrieving regulations of a plurality of countries. These regulations may be stored so that server 110 may use them to respond to requests from a user. In particular embodiments, these regulations may be the loan regulations and tax regulations of these countries. These regulations may also include business regulations. In some embodiments, server 110 may also retrieve and store client preferences.

In step 310, server 110 may receive a request for a loan in a designated country. The request may specify the client, the loan amount, the loan type, and the loan currency. Based on the request, server 110 may determine which regulations to reference. For example, server 110 may reference Chinese regulations if the request indicates that a company in the United States is requesting a loan to China.

In step 315, server 110 may determine whether the regulations of the designated country are in the retrieved regulations. If not, server 110 may retrieve the regulations of the designated country from databases 150 in step 320 and continue to step 325. If the regulations were in the retrieved regulations, server 110 may continue to step 325. Using the previous example, if the Chinese regulations are not stored in server 110 when it receives the request, server 110 will retrieve and store the Chinese regulations. Otherwise, server 110 will use the stored Chinese regulations to respond to the request.

In steps 325 through 340, server 110 may determine various aspects of a response to the request based on the stored regulations. In step 325, server 110 may determine a service location for the loan. Server 110 may then determine the tax withholding for the loan in step 330. In step 335, server 110 may determine whether a license is required for the loan. For example, server 110 may determine whether an EEA passport is required to service the loan. Server 110 may then continue to step 340 to determine requirements and restrictions for the loan. As an example, server 110 may determine booking requirements, documentation requirements, execution requirements, and disclosure obligations associated with the loan.

Server 110 may conclude in step 345 by communicating a response using the determined information. The communicated response may be used by a user to determine how best to service the loan in the designated country. In this manner, the user may be confident that the loan provider has complied with the laws and regulations of China without having to call various experts on Chinese regulations and having to perform multiple data pulls from various databases.

Although the present disclosure includes several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

1. An apparatus, comprising:
a memory unit operable to:
store loan regulations of a plurality of countries; and
store tax regulations of the plurality of countries; and
a processing unit communicatively coupled to the memory unit and operable to:
receive a country designation and a currency designation;
determine, based at least in part upon the loan regulations associated with the country designation, at least one service location that is allowed to service a loan according to the currency designation and the country designation; and
determine, based at least in part upon the retrieved tax regulations associated with the country designation, a tax withholding on the loan.

2. The apparatus of claim 1, wherein:
the memory unit is further operable to store a service preference of a designated client associated with the loan; and
the processing unit is further operable to determine, based at least in part upon the service preference, a priority for the at least one service location.

3. The apparatus of claim 1, wherein the processing unit is further operable to determine, based at least in part upon the loan regulations associated with the country designation, that same day funding is allowed for the loan.

4. The apparatus of claim 1, wherein the processing unit is further operable to determine, based at least in part upon the loan regulations associated with the country designation, that a swingline loan is allowed.

5. The apparatus of claim 1, wherein the loan regulations associated with the country designation indicate whether a cross border license is required to service a loan to the designated country.

6. The apparatus of claim 1, wherein the processing unit is further operable to determine, based at least in part upon the loan regulations associated with the country designation, at least one of a booking requirement, a documentation requirement, and an execution requirement associated with the loan.

7. The apparatus of claim 1, wherein the processing unit is further operable to determine, based at least in part upon the loan regulations associated with the country designation, at least one disclosure associated with servicing the loan.

8. The apparatus of claim 1, wherein the processing unit is further operable to:
store business regulations associated with the country designation; and
determine, based at least in part upon the business regulations associated with the country designation, at least one of a restriction and a requirement associated with soliciting business in the country designation.

9. The apparatus of claim 1, wherein the processing unit is further operable to:
store business regulations associated with the country designation; and
determine, based at least in part upon the business regulations associated with the country designation, at least one restriction associated with providing business advice in the country designation.

10. The apparatus of claim 1, wherein:
the memory unit is further operable to store employee information; and
the processing unit is further operable to determine, based at least in part upon the employee information, at least one employee who can assist in servicing the loan in the language of the country designation.

11. A method of assigning privileges to a user, comprising:
retrieving loan regulations of a plurality of countries;
retrieving tax regulations of the plurality of countries;
receiving a country designation and a currency designation;
determining, by a processor, based at least in part upon the loan regulations associated with the country designation, at least one service location that is allowed to service a loan according to the currency and the country designation; and
determining, by the processor, based at least in part upon the retrieved tax regulations associated with the country designation, a tax withholding on the loan.

12. The method of claim 11, further comprising:
receiving a client designation;
retrieving a service preference of the designated client; and
determining, based at least in part upon the service preference, a priority for the at least one service location.

13. The method of claim 11, further comprising determining, based at least in part upon the loan regulations associated with the country designation, that same day funding is allowed for the loan.

14. The method of claim 11, further comprising determining, based at least in part upon the loan regulations associated with the country designation, that a swingline loan is allowed.

15. The method of claim 11, wherein the loan regulations associated with the country designation indicate whether a cross border license is required to service a loan to the country designation.

16. The method of claim 11, further comprising determining, based at least in part upon the loan regulations associated with the country designation, at least one of a booking requirement, a documentation requirement, and an execution requirement associated with the loan.

17. The method of claim 11, further comprising determining, based at least in part upon the loan regulations associated with the country designation, at least one disclosure associated with servicing the loan.

18. The method of claim 11, further comprising:
retrieving business regulations associated with the country designation; and
determining, based at least in part upon the business regulations associated with the country designation, at least one of a restriction and a requirement associated with soliciting business in the country designation.

19. The method of claim 11, further comprising:
retrieving business regulations associated with the country designation; and
determining, based at least in part upon the business regulations associated with the country designation, at least one restriction associated with providing business advice in the country designation.

20. The method of claim 11, further comprising:
retrieving employee information; and
determining, based at least in part upon the employee information, at least one employee who can assist in servicing the loan in the language of the country designation.

21. One or more computer-readable non-transitory storage media embodying software that is operable when executed to:
retrieve loan regulations of a plurality of countries; and
retrieve tax regulations of the plurality of countries; and
receive a country designation and a currency designation;
determine, based at least in part upon the loan regulations associated with the country designation, at least one service location that is allowed to service a loan according to the currency designation and the country designation; and
determine, based at least in part upon the retrieved tax regulations associated with the country designation, a tax withholding on the loan.

22. The media of claim 21, further operable when executed to:
retrieve a service preference of a designated client associated with the loan; and
determine, based at least in part upon the service preference, a priority for the at least one service location.

23. The media of claim 21, further operable when executed to determine, based at least in part upon the loan regulations associated with the country designation, that same day funding is allowed for the loan.

24. The media of claim 21, further operable when executed to determine, based at least in part upon the loan regulations associated with the country designation, that a swingline loan is allowed.

25. The media of claim 21, wherein the loan regulations associated with the country designation indicate whether a cross border license is required to service a loan to the country designation.

26. The media of claim 21, further operable when executed to determine, based at least in part upon the loan regulations associated with the country designation, at least one of a booking requirement, a documentation requirement, and an execution requirement associated with the loan.

27. The media of claim 21, further operable when executed to determine, based at least in part upon the loan regulations associated with the country designation, at least one disclosure associated with servicing the loan.

28. The media of claim 21, further operable when executed to:
retrieve business regulations associated with the country designation; and
determine, based at least in part upon the business regulations associated with the country designation, at least one of a restriction and a requirement associated with soliciting business in the country designation.

29. The media of claim 21, further operable when executed to:
retrieve business regulations associated with the country designation; and
determine, based at least in part upon the business regulations associated with the country designation, at least one restriction associated with providing business advice in the country designation.

30. The media of claim 21, further operable when executed to:
retrieve employee information; and
determine, based at least in part upon the employee information, at least one employee who can assist in servicing the loan in the language of the designated country.
